(19) United States
(12) Patent Application Publication
(10) Pub. No.: US 2025/0162484 A1
(43) Pub. Date: May 22, 2025

(54) Car refrigerator with compact structure

(71) Applicant: Gangyao Long, Foshan (CN)

(72) Inventor: Gangyao Long, Foshan (CN)

(21) Appl. No.: 19/031,084

(22) Filed: Jan. 17, 2025

(30) Foreign Application Priority Data
Dec. 1, 2024 (CN) CN 202422943078.9

(51) Int. Cl. B60N 3/10; F25D 23/02; F25D 31/00

(52) U.S. Cl. CPC B60N 3/104; F25D 23/026; F25D 31/006

(57) ABSTRACT

The present disclosure provides a car refrigerator with a compact structure, which comprises a refrigerator body, a refrigerating chamber and a refrigerating mechanism disposed in the refrigerator body, wherein the refrigerating chamber comprises a bottom wall, two opposite side walls extending vertically upward from the bottom wall, a top wall disposed in parallel with and spaced from the bottom wall, and a first wall and a second wall disposed between the bottom wall and the top wall; the second wall is step-shaped and comprises a lower part connected to the bottom wall, an upper part connected to the top wall and a platform part connected to the lower part and the upper part; and the refrigerating mechanism is located on the platform part. The second wall is configured to be step-shaped, and the refrigerating mechanism of the refrigerate mechanism is disposed on the platform part, so that the space in the refrigerator body can be fully utilized, and the volume of the refrigerating chamber can be expanded as much as possible on the basis of ensuring the normal operation of the car refrigerator

### CROSS-REFERENCE TO RELATED APPLICATIONS

The present application claims priority to Chinese Patent Application No. CN 202422943078.9, filed on Dec. 1, 2024, the content of which is incorporated herein by reference in its entirety.

### TECHNICAL FIELD

The present utility model relates to the technical field of automobile accessories, particularly to a car refrigerator of a compact structure.

### BACKGROUND

With the development of society, cars have become the main means of transportation, and car refrigerators have been widely used because of their convenience.

The car refrigerator usually used is a small refrigerator placed independently in the car. During the driving process of the car, especially on the bumpy road, it is difficult to guarantee the stability of the car refrigerator, and because of the limited space in the car, the capacity of the refrigerator is small and the use experience is not good.

### SUMMARY

In view of the above, there is a need to propose a car refrigerator of a compact structure to increase the capacity of the refrigerator.

The present utility model provides a car refrigerator of a compact structure, which includes a refrigerator body, a refrigerating chamber and a refrigerating mechanism disposed in the refrigerator body, wherein the refrigerating chamber includes a bottom wall and two opposite side walls extending vertically upward from the bottom wall and a top wall disposed in parallel with and spaced from the bottom wall, and a first wall and a second wall disposed between the bottom wall and the top wall, wherein the second wall is step-shaped and includes a lower part connected to the bottom wall, an upper part connected to the top wall and a platform part connected to the lower part and the upper part; and the refrigerating mechanism is located on the platform part.

Preferably, the refrigerating mechanism includes a compressor and a fan, and the compressor and the fan are disposed side by side above the platform part.

Preferably, the car refrigerator further includes a refrigerator body fitting detachably connected with the refrigerator body, and the refrigerating mechanism further includes a power adapter accommodated in the refrigerator body fitting.

Preferably, the refrigerator body has an extension surface extending from the platform part in a direction away from the refrigerating chamber, and the extension surface is provided with a first ventilation hole and a second ventilation hole, wherein a first baffle is disposed between the first ventilation hole and the second ventilation hole.

Preferably, two sides of the refrigerator body fitting are respectively provided with a third ventilation hole and a fourth ventilation hole (54), wherein a second baffle is disposed between the third ventilation hole and the fourth ventilation hole.

Preferably, the refrigerator body fitting has a guide surface for guiding an air flow direction, and the guide surface is an inclined surface extending obliquely upward from below the third ventilation hole and the fourth ventilation hole towards the second baffle.

Preferably, the first wall is disposed obliquely, and an included angle ∠α between the first wall and the bottom wall is an obtuse angle.

Preferably, the refrigerator body includes a pivotable refrigerator door disposed at the top, and a rotating shaft of the refrigerator door is close to the first wall.

The car refrigerator with a compact structure provided by the present utility model includes a refrigerator body, a refrigerating chamber and a refrigerating mechanism disposed in the refrigerator body, wherein the refrigerating chamber comprises a bottom wall, two opposite side walls extending vertically upward from the bottom wall, a top wall disposed in parallel with and spaced from the bottom wall, and a first wall and a second wall disposed between the bottom wall and the top wall; the second wall is step-shaped and comprises a lower part connected to the bottom wall, an upper part connected to the top wall and a platform part connected to the lower part and the upper part; and the refrigerating mechanism is located on the platform part. The second wall is configured to be step-shaped, and the refrigerating mechanism of the refrigerate mechanism is disposed on the platform part, so that the space in the refrigerator body can be fully utilized, and the volume of the refrigerating chamber can be expanded as much as possible on the basis of ensuring the normal operation of the car refrigerator.

### BRIEF DESCRIPTION OF DRAWINGS

In order to explain the specific embodiment of the present utility model or the technical solution in the prior art more clearly, the drawings needed in the description of the specific embodiment or the prior art will be briefly introduced below. Obviously, the drawings in the following description are some embodiments of the present utility model. For those skilled in the art, other drawings can be obtained according to these drawings without creative work.

FIG. 1 is a combined schematic diagram of a car refrigerator provided by one embodiment;

FIG. 2 is an exploded schematic view of the car refrigerator provided by one embodiment;

FIG. 3 is an exploded schematic view of the car refrigerator provided by one embodiment from another perspective;

FIG. 4 is a sectional view of a car refrigerator provided by one embodiment;

FIG. 5 is a schematic diagram of the refrigerator body fitting of the car refrigerator provided by one embodiment;

FIG. 6 is a schematic view of an open state of the refrigerator door of the car refrigerator provided by one embodiment;

FIG. 7 is a schematic diagram of an open state of the refrigerator door of the car refrigerator provided by one embodiment; and

FIG. 8 is a diagram of the usage scene of the car refrigerator provided by an embodiment after installation.

### DESCRIPTION OF EMBODIMENTS

The technical solution of the present utility model will be described clearly and completely with the attached drawings. Obviously, the described embodiment is part of, rather than all of the embodiments of the present utility model. Based on the embodiment of the present utility model, all other embodiments obtained by those skilled in the art without creative labor belong to the protection scope of the present utility model.

In the description of this utility model, it should be noted that if the terms “center”, “upper”, “lower”, “left”, “right”, “vertical”, “horizontal”, “inside” and “outside” appear, the indicated orientation or position relationship is based on the orientation or position relationship shown in the drawings, which is only for the convenience of describing the utility model and simplifying the description, and does not indicate or imply that the device or element must have a specific orientation, be constructed and operated in a specific orientation, therefore it cannot be construed as a limitation of the present utility model. In addition, the terms “first”, “second” and “third” are used for descriptive purposes only, and cannot be construed as indicating or implying relative importance.

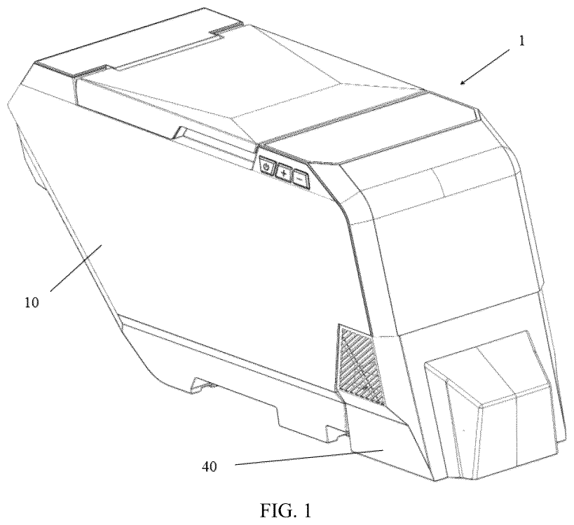

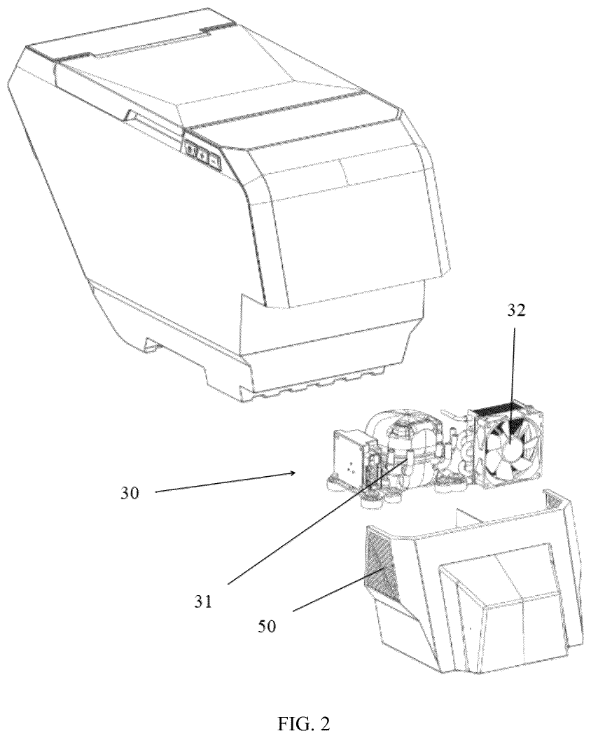

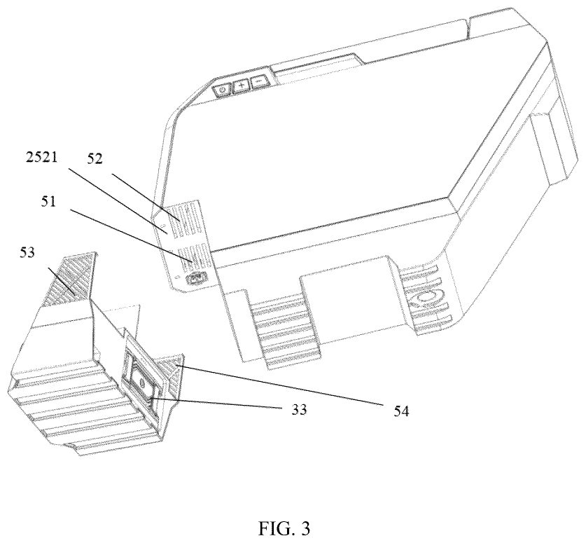

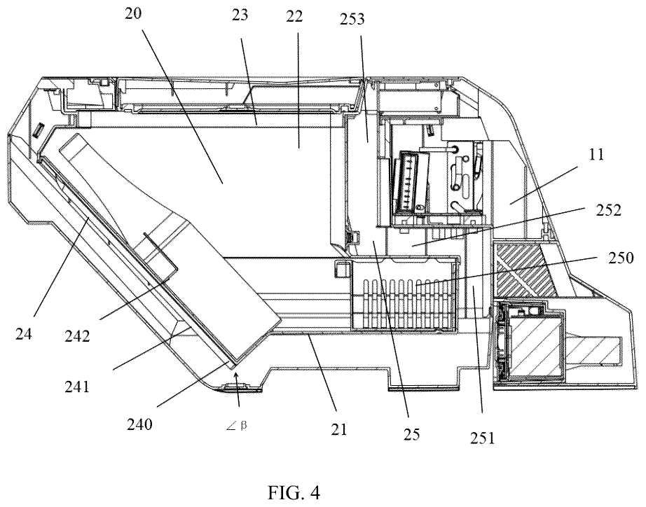

As shown in FIGS. 1-4, the car refrigerator 1 provided by the present utility model includes a refrigerator body 10, a refrigerating chamber 20 and a refrigerating mechanism 30 disposed in the refrigerator body 10.

The refrigerating chamber 20 includes a bottom wall 21, two opposite side walls 22 extending vertically upward from the bottom wall 21, a top wall 23 disposed in parallel with and spaced from the bottom wall 21, and a first wall 24 and a second wall 25 disposed between the bottom wall 21 and the top wall 23. The first wall 24 is obliquely disposed. Specifically, the included angle ∠α between the first wall 24 and the bottom wall 21 is an obtuse angle, and the degree of ∠α is between 130° and 140°, preferably 135°.

Compared with a common refrigerator with a cuboid refrigerator, the car refrigerator 1 of the present utility model is designed with the inclined first wall 24, so that the car refrigerator 1 and the refrigerating cha 20 therein can be adapted to the space inside the vehicle, specifically the space between the driver's seat and the passenger's seat, thereby maximizing the volume of the refrigerator 20 and improving the capacity of the car refrigerator 1.

In this embodiment, a first groove 240 is formed at the junction of the first wall 24 and the bottom wall 21. Preferably, the included angle 2B between the surface of the first groove 240 connected with the first wall 24 and the surface connected with the bottom wall 21 is approximately 90°. In this way, when it is necessary to refrigerate beverages, beverage containers such as kettles and wine bottles can be placed on the first wall 24 obliquely, and the bottom of the beverage container can abut against the first groove 240, so that the inclined first wall 24 can be used to support the beverage container to be placed obliquely, and the car refrigerator 1 can accommodate high beverage containers, without the need to worry about the possibility that beverage containers fall down due to braking or bumping of the vehicle. Further, the surface of the first wall 24 is provided with two elongated grooves 241 disposed in parallel and at intervals, so that there will be no collision between two beverage containers placed on the first wall 24 side by side.

In an improved embodiment, two sides of the first wall 24 are also provided with clamping grooves 242, and when small articles need to be placed, an organizer, such as a hanging basket, can be clamped with the clamping grooves 242. It can be appreciated that the organizer and the first wall 24 can also be connected by magnetic attraction.

On the other hand, the second wall 25 is step-shaped, and includes a lower part 251 connected to the bottom wall 21, an upper part 253 connected to the top wall 23, and a platform part 252 connected to the lower part 251 and the upper part 253. The refrigerating mechanism 30 is located above the platform part 252, and the accommodating space 250 is located below the platform part 252. In this embodiment, the accommodating space 250 is provided with a movable ice shelf. Since the accommodating space 250 is located directly below the refrigerating mechanism, the refrigerating effect at this position is the best. The ice shelf is placed in the accommodating space 250 as a drawer, and there can be two sections of cold storage and freezing in the car refrigerator 1.

The refrigerating mechanism 30 includes a compressor 31 and a fan 32. The compressor 31 and the fan 32 are disposed substantially side by side above the platform part 252 and located outside the refrigerating chamber 20. The refrigerating mechanism 30 is disposed on the platform part 252, which makes full use of the space of the refrigerator body 10, so that the car refrigerator 1 is compact while having a large capacity.

The refrigerating mechanism 30 further includes a power adapter 33 that is point-linked with the compressor 31 and the fan 32. The car refrigerator 1 further includes a refrigerator body fitting 40 that is detachably connected with the refrigerator body 10. The power adapter 33 is accommodated in the refrigerator body fitting 40, that is, the power adapter 33 does not occupy the space inside the refrigerator body 10.

In order to facilitate heat dissipation of the refrigerating mechanism 30, the refrigerator body 10 and the refrigerator body fittings 40 jointly form a heat dissipation structure 50. Specifically, the refrigerator body 10 is provided with a first ventilation hole 51 near the compressor 31, and a second ventilation hole 52 near the fan 32. The refrigerator body fitting 40 is provided with a third ventilation hole 53 near the first ventilation hole 51 and a fourth ventilation hole 54 near the second ventilation hole 52. A first baffle 11 is provided between the first ventilation hole 51 and the second ventilation hole 52, and a second baffle 41 is provided between the third ventilation hole 53 and the fourth ventilation hole 54. When the fan 32 is started, air enters the refrigerator body fitting 40 from outside the refrigerator body fitting 40 through the fourth ventilation hole 54, then enters the refrigerator body 10 through the second ventilation hole 52, flows through the compressor 31, enters the refrigerator body fitting 40 with the heat of the compressor 31 through the first ventilation hole 51, and then is discharged through the third ventilation hole 53.

In this embodiment, since the compressor 31 and the fan 32 are located in the upper space in the refrigerator body 10, the refrigerator body fitting 40 is located roughly below the compressor 31 and the fan 32, the first ventilation hole 51 and the second ventilation hole 52 are located on the extension surface 2521 of the platform part 252, and the third ventilation hole 53 and the fourth ventilation hole 54 are located on both sides of the refrigerator body fitting 40. That is, the air enters the refrigerator body fitting 40 from one side of the refrigerator body fitting 40, passes upward through the extension surface of the platform part 252 to enter the refrigerator body 10, and then passes down through the extension surface 2521 of the platform part 252 to enters the refrigerator body fitting 40 and is discharged from the other side.

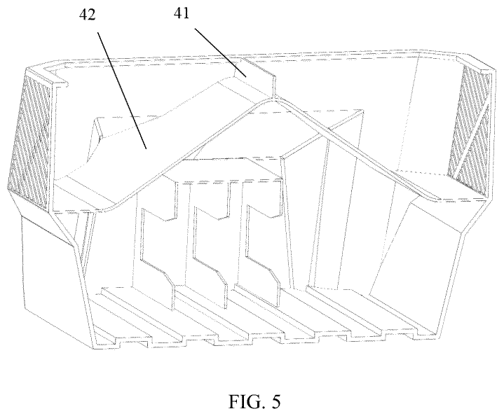

As shown in FIG. 5, in an improved embodiment, the refrigerator body fitting 40 has a guide surface 42 for guiding the direction of air flow. The guide surface 42 is an inclined surface extending obliquely upward from below the third ventilation hole 53 and the fourth ventilation hole 54 towards the second baffle 41.

It can be appreciated that in other embodiments, the compressor 31 and the fan 32 can be located on the same plane as the refrigerator body fitting 40. In this case, the first ventilation hole 51 and the second ventilation hole 52 can be disposed on the surface of the compressor 31 and the fan 32 facing the refrigerator body fitting 40. As long as the refrigerator body fitting 40 with the third ventilation hole 53 and the fourth ventilation hole 54 is used to assist the compressor 31 to dissipate heat, it belongs to the scope of the technical solution of this utility model.

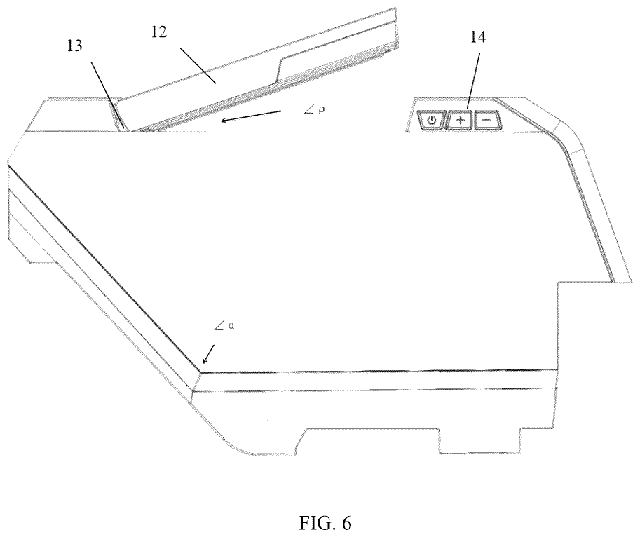

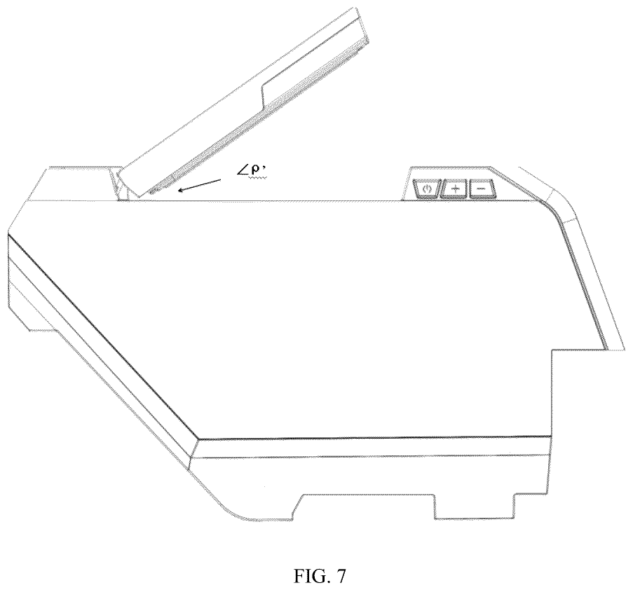

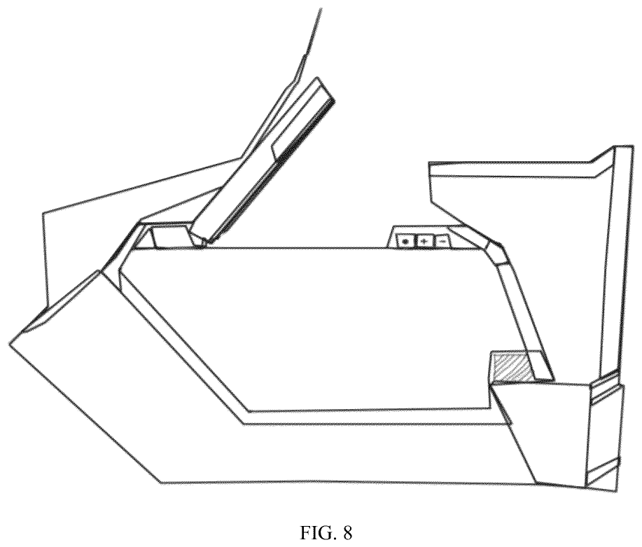

Further, as shown in FIGS. 6-8, the refrigerator body 10 includes a pivotable refrigerator door 12 disposed at the top, and the rotating shaft 13 of the refrigerator door 12 is close to the first wall 24. In this embodiment, the car refrigerator 1 is located between the driver's seat and the passenger's seat, the first wall 24 is located close to the front of the car, and the second wall 25 is close to the driver, so the door opening direction of the refrigerator door 12 allows the driver to conveniently observe and take articles in the refrigerator.

The rotating shaft 13 is a damping rotating shaft, and the refrigerator door 12 can suspend when pivoting around the rotating shaft 13, that is, when the user can lift the refrigerator door 12 to any height by hand, the refrigerator door 12 can stay at that height.

Preferably, the included angle between the refrigerator door 12 and the top surface of the refrigerator body 10 is between 0° and 60°.

It can be appreciated that the surface of the refrigerator door 12 facing the refrigerating chamber 20 is actually at least a part of the top wall 23 of the refrigerating chamber 20, and the top of the refrigerator body 10 is also provided with a display control panel 14 for the driver to control the car refrigerator 1.

The above embodiments are only used to illustrate, rather than limit the technical solution of the present utility model. Although the present utility model has been described in detail with reference to the above-mentioned embodiments, those skilled in the art should appreciate that the technical solution recorded in the above-mentioned embodiments can still be modified, or some or all of its technical features can be replaced equally. However, these modifications or substitutions do not make the essence of the corresponding technical solution deviate from the scope of the technical solution of each embodiment of the present utility model.

What is claimed is:

1. A car refrigerator (1) with a compact structure, comprising a refrigerator body (10), a refrigerating chamber (20) and a refrigerating mechanism (30) disposed in the refrigerator body (10), wherein the refrigerating chamber (20) comprises a bottom wall (21) and two opposite side walls (22) extending vertically upward from the bottom wall (21) and a top wall (23) disposed in parallel with and spaced from the bottom wall (21), and a first wall (24) and a second wall (25) disposed between the bottom wall (21) and the top wall (23), wherein the second wall (25) is step-shaped and comprises a lower part (251) connected to the bottom wall (21), an upper part (253) connected to the top wall (23) and a platform part (252) connected to the lower part (251) and the upper part (253); and the refrigerating mechanism (30) is located on the platform part (252).

2. The car refrigerator (1) with a compact structure according to claim 1, wherein the refrigerating mechanism (30) comprises a compressor (31) and a fan (32), and the compressor (31) and the fan (32) are disposed side by side above the platform part (252).

3. The car refrigerator (1) with a compact structure according to claim 2, wherein the car refrigerator (1) further comprises a refrigerator body fitting (40) detachably connected with the refrigerator body (10), and the refrigerating mechanism (30) further comprises a power adapter (33) accommodated in the refrigerator body fitting (40).

4. The car refrigerator (1) with a compact structure according to claim 3, wherein the refrigerator body (10) has an extension surface (2521) extending from the platform part (252) in a direction away from the refrigerating chamber (20), and the extension surface is provided with a first ventilation hole (51) and a second ventilation hole (52), wherein a first baffle (11) is disposed between the first ventilation hole (51) and the second ventilation hole (52).

5. The car refrigerator (1) with a compact structure according to claim 4, wherein two sides of the refrigerator body fitting (40) are respectively provided with a third ventilation hole (53) and a fourth ventilation hole (54), wherein a second baffle (41) is disposed between the third ventilation hole (53) and the fourth ventilation hole (54).

6. The car refrigerator (1) with a compact structure according to claim 5, wherein the refrigerator body fitting (40) has a guide surface (42) for guiding an air flow direction, and the guide surface (42) is an inclined surface extending obliquely upward from below the third ventilation hole (53) and the fourth ventilation hole (54) towards the second baffle (41).

7. The car refrigerator (1) with a compact structure according to claim 1, wherein the first wall (24) is disposed obliquely, and an included angle/a between the first wall (24) and the bottom wall (21) is an obtuse angle.

8. The car refrigerator (1) with a compact structure according to claim 1, wherein the refrigerator body (10) comprises a pivotable refrigerator door (12) disposed at the top, and a rotating shaft (13) of the refrigerator door (12) is close to the first wall (24).
